(19) United States
(12) Patent Application Publication
(10) Pub. No.: US 2009/0150884 A1
(43) Pub. Date: Jun. 11, 2009

(54) COMPUTER AND METHOD OF PROVIDING SOFTWARE USER INTERFACE

(75) Inventor: Yoshio Fukuda, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/034,274

(22) Filed: Feb. 20, 2008

(30) Foreign Application Priority Data
Feb. 21, 2007 (JP) 2007-040566

(51) Int. Cl. G06F 9/455

(52) U.S. Cl. 718/1

(57) ABSTRACT

A computer and method thereof including a first settings changing user interface application running on a first operating system, a second settings changing user interface application running on a second operating system, where the second settings changing user interface application provides an equal function to a part of a user interface function provided by the first settings changing user interface application. The second settings changing user interface application inputs a request of changes of settings the first settings changing user interface application executes the changes of settings based on the request and the second settings changing user interface application outputs a result of the changes of settings executed by the first settings changing user interface application.

### CROSS-REFERENCE TO RELATED APPLICATIONS

This application is based upon and claims the benefit of priority from the prior Japanese Patent Application No. 2007-40566 filed on Feb. 21, 2007, the entire contents of which are incorporated herein by reference.

### BACKGROUND

1. Field

The present invention relates to a computer and method of providing a software user interface.

2. Description of the Related Art

A computer provides a user interface to exchange message(s) between a user and a computer. Generally, software running on an operating system (hereinafter referred to as an OS) controls a display of a user interface on a screen of a display device. Also, the computer provides hardware interface, including, for example, a volume adjustment button, a power button, etc., as a part of the user interface.

There exists a problem with a typical software interface in that a user can not use a computer or a reaction of the computer to a user's operation is slow, depending on an operating condition of the computer. For example, first, if an OS or an application hangs up (i.e., stops working, processing a request or instruction), a user can no longer perform an operation employing the software interface. Second, when a system load is high, the computer response to the operation through the software interface is slow. Third, when operation setting(s) of the computer are changed due to an operational error of the user, the interface is not displayed at a normal location on a display screen. On the other hand, a hardware interface is fixed to a computer and less extensible.

As a technique for using a single computer to perform as multiple computers, a Virtual Machine (VM) is well known. The Virtual Machine, like other applications (APs) running on a host OS, is executed as one process on the host OS by the computer, as shown in FIG. 1. Accordingly, a guest OS on the Virtual Machine, like the applications running on the host OS, can be temporarily stopped. Also, even if a response speed of the guest OS on the Virtual Machine is decreased, the host OS and other applications running on the host OS are less susceptible to lower speed. For typical Virtual Machine products, it is possible to switch the Virtual Machine on or off, depending on the virtual device levels (sound, network, etc.), as the setting items of the Virtual Machine.

As documents related with a multi OS or Virtual Machine, there are Japanese Patent Application Laid-Open No. 11-149385, Japanese Patent Application Laid-Open No. 2001-101034 and Japanese Patent Application Laid-Open No. 2002-318699.

### SUMMARY

The disclosed computer and method of providing software user interface includes running a first settings changing user interface application on a first operating system, running a second settings changing user interface application on a second operating system, where the second settings changing user interface application provides an equal function to a part of a user interface function provided by the first settings changing user interface application.

The disclosed second settings changing user interface application inputs a request for changes of settings, the first settings changing user interface application executes the changes of settings based on the request inputted by the second settings changing user interface application, and the second settings changing user interface application outputs a result of the changes of settings executed by the first settings changing user interface application.

The disclosed settings changing user interface application is executed on an operating system which communicates with another operating system and executes a change of settings requested from the other operating system.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is an explanatory diagram of a Virtual Machine;

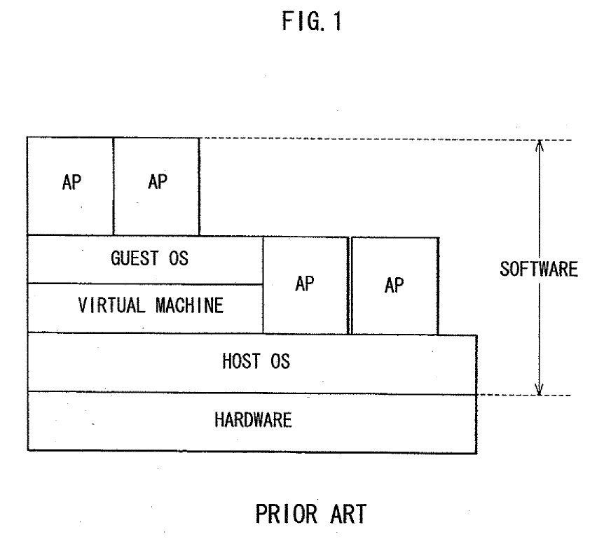

FIG. 2 is an view of a notebook personal computer as a computer;

FIG. 3 is a diagram illustrating a software configuration of a notebook personal computer as shown in FIG. 2;

FIG. 4 is a diagram illustrating a settings changing operation under the software configuration as shown in FIG. 3;

FIG. 5 is a flowchart illustrating a procedure of a second settings changing UI application on a host OS; and

FIG. 6 is a flowchart illustrating a procedure of a settings changing service on a guest OS.

### DETAILED DESCRIPTION OF THE EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

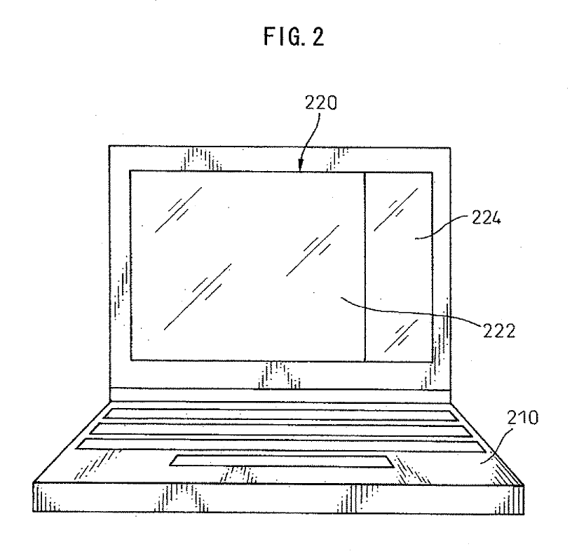

FIG. 2 is a view of a notebook personal computer (PC) according to an embodiment of the present invention. The personal computer contains a processor, a memory, etc., and including other component(s) of computer. The personal computer shown in FIG. 2 includes a keyboard 210, a display 220 and so on as input/output devices receiving and/or transmitting information from or to a user. The processor performs a process in accordance with instruction(s) from software loaded into the memory. Although FIG. 2 is described by referring to specific component(s) of a personal computer, the present invention may be implemented on any machine or device.

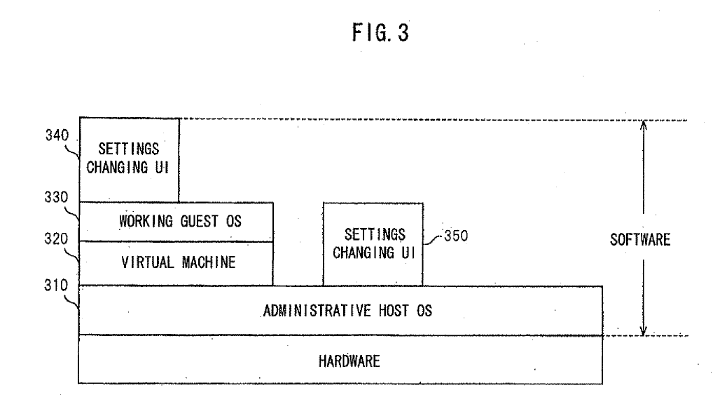

FIG. 3 is a diagram showing the software configuration of the notebook personal computer shown in FIG. 2. In FIG. 3, reference numeral 310 denotes an administrative host OS (a second OS), reference numeral 320 denotes a Virtual Machine performed as one process on the administrative host OS 310, and reference numeral 330 denotes a working guest OS (a first OS) executed on the Virtual Machine 320.

Also, reference numeral 340 denotes a first settings changing user interface (UI) application running on the working guest OS 330, and reference numeral 350 denotes a second settings changing user interface (UI) application running on the administrative host OS 310 and providing an equal function to a part of a user interface (UI) function provided by the first settings changing user interface (UI) application 340. The second settings changing user interface (UI) application of the administrative host OS 310 enables execution of operation(s) similar to a part of a user interface (UI) function provided by the first settings changing user interface (UI) application 340.

Using Virtual Machine (VM) techniques, a normally used OS can be installed as the working guest OS 330 on the VM into the computer, as shown in FIG. 3. And an application 350 managing a user interface (UI) required for a user to always utilize is prepared as running on the administrative host OS 310. For example, as part of the settings changing UI application 340 running on the working guest OS 330, a sound volume control, is mounted as the application 350 running on the administrative host OS 310.

On the display screen of a display 220 in FIG. 2, reference numeral 222 denotes a portion displayed by the working guest OS 330, and reference numeral 224 denotes a portion displayed by the second settings changing UI application 350 running on the administrative host OS 310.

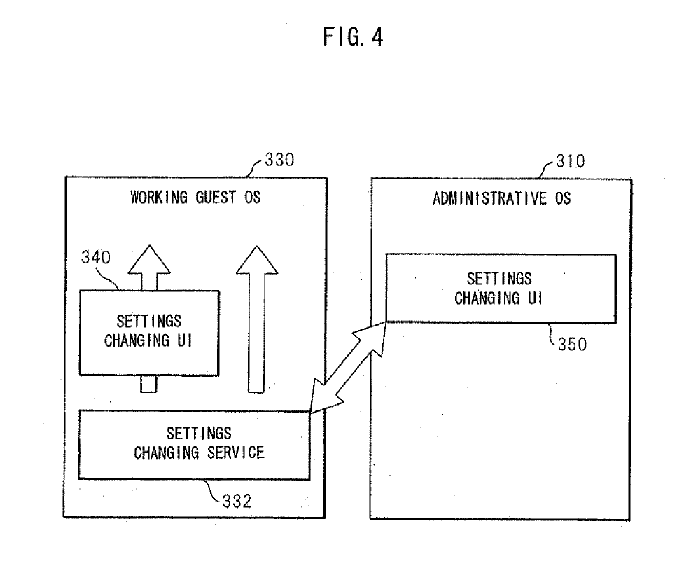

FIG. 4 is a diagram explaining a settings changing operation under the software configuration as shown in FIG. 3. The guest OS and the host OS in the Virtual Machine technique can communicate with each other via a virtual network. The second settings changing UI application 350 running on the administrative host OS 310 communicates with a settings changing service 332 within the working guest OS 330 via the virtual network, and makes a notification of the settings changing operation through the settings changing UI to the settings changing server 332. The settings changing server 332 changes the settings of the working guest OS 330 in accordance with the notification.

That is, the settings changing server 332 operates the first settings changing UI application 340 running on the working gust OS 330 by emulating a mouse/keyboard operation of a user, or directly changes the settings through an API (Application Programming Interface) of the OS standard. The second settings changing UI application 350 of the administrative host OS 310 provides a feedback of a process performed upon a user's operation to the user. A specific procedure will be described below.

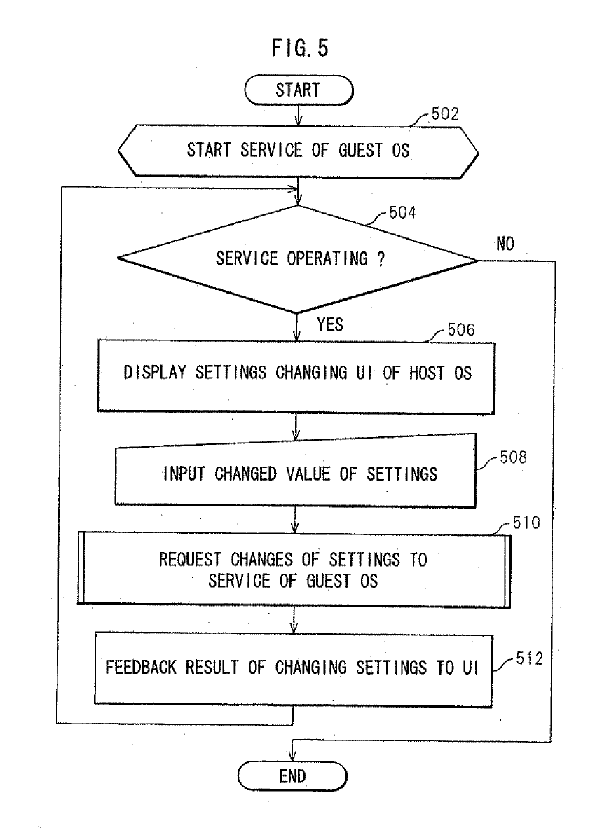

FIG. 5 is a flowchart showing a procedure of the second settings changing UI application 350 of the administrative host OS 310. First of all, the settings changing UI application 350 starts the settings changing service 332 of the working guest OS 330 (operation 502). Next, the settings changing UI application 350 judges whether or not the service 332 is operating (operation 504). If the service 332 is not operating, the settings changing UI application 350 ends this process.

On the other hand, if the service 332 is operating, the settings changing UI application 350 displays the settings changing UI of the administrative host OS on a part of the screen 224 (FIG. 2) (operation 506). Next, the settings changing UI application 350 receives a settings changing operation through the settings changing UI and inputs a request made by the operation (operation 508). Next, the settings changing UI application 350 requests changes of the settings to the settings changing service 332 of the working guest OS 330 (operation 510).

A process performed by the settings changing service 332 receiving the request is described below in detail.

Lastly, the settings changing UI application 350 receiving a result of changing the settings from the settings changing service 332 provides a feedback of a result to the settings changing UI (operation 512). Thereafter, the procedure returns to operation 504 to repeat the above process.

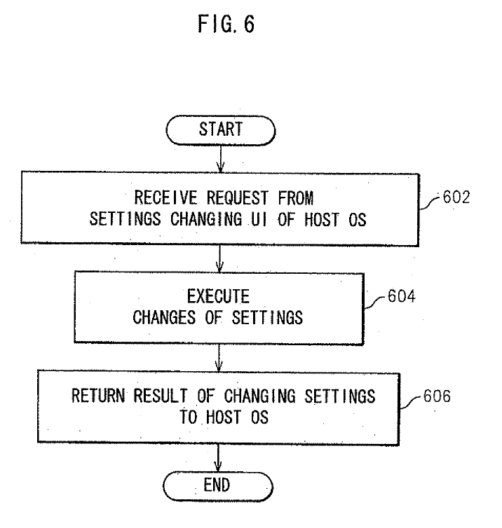

FIG. 6 is a flowchart showing a procedure of the settings changing service 332 on the working guest OS 330. First, the settings changing service 332 receives a request for changing the settings from the second settings changing UI application 350 of the administrative host OS 310 (operation 602).

Next, the settings changing service 332 change(s) the settings in accordance with the received request (operation 604). Lastly, the settings changing service 332 returns the result of changing the settings to the second settings changing UI application 350 of the administrative host OS 310 (operation 606), and this process is ended.

In an embodiment of the present invention, even when a normally used guest OS has a high processing load and a response to a mouse operation is worse (slow), it is possible to perform a necessary operation using the settings changing UI of the host OS. Usually, when a processing load of the OS is high, the response to a UI operation is worse, and a user therefore can not know whether or not the intended operation is performed and may become confused. According to the present invention, it is possible to return a result of changing settings through the settings changing UI of the host OS, irrespective of a state of the guest OS, whereby such a problem can be solved.

While specific examples of operation(s) such as a mouse operation are provided herein, the present invention is not limited to any particular type of operation request and may include any type of instruction requesting operation(s) executable via a computer.

Also, the settings changing UI of a general OS may be hidden without an intention of a user, and is problematical in supporting a user who is a beginner or does not possess necessary knowledge to access and change setting(s). The present invention can solve this problem because the settings changing UI of the administrative host OS is always displayed at the same location (a predetermined or dedicated location) on the screen.

Specifically, according to an embodiment of the present invention, when a music or alarm is reproduced in large volume during a meeting, for example, a user can stop the reproduction or reduce the volume at once. Also, the user can switch a screen where confidential information is displayed to another screen or hide it at once. Also, an interface for switching Japanese-language input can be displayed at the same location on the screen.

The present invention is not to be considered limited to the above-mentioned embodiment. It will be obvious to those skilled in the art that various changes may be made without departing from the scope of the present invention.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A computer for providing a software user interface, comprising:
a first operating system;
a second operating system;
a first settings changing user interface application running on the first operating system; and
a second settings changing user interface application running on the second operating system, the second settings changing user interface application providing an equal function to a part of a user interface function provided by the first settings changing user interface application;
wherein the second settings changing user interface application inputs a request of changes of settings, the first settings changing user interface application executes the changes of settings based on the request input by the second settings changing user interface application and the second settings changing user interface application outputs a result of the changes of settings executed by the first settings changing user interface application.

2. The computer according to claim 1, wherein the second settings changing user interface application operates as a host operating system by being executed as a process on the second operating system and the first operating system operates as a guest operating system on the virtual machine.

3. The computer according to claim 1, wherein the second settings changing user interface application displays a user interface on a screen of a display in a predetermined location.

4. The computer according to claim 1, wherein the first operating system is used as a working operating system.

5. A computer readable storage medium storing a program for providing a software user interface to cause a computer to execute operations, the storage medium comprising:
providing a first settings changing user interface application running on a first operating system; and
providing a second settings changing user interface application running on a second operating system, the second settings changing user interface application providing an equal function to a part of a user interface function provided by the first settings changing user interface application;
wherein the second settings changing user interface application inputs a request of changes of settings, the first settings changing user interface application executes the changes of settings based on the request input by the second settings changing user interface application and the second settings changing user interface application outputs a result of the changes of settings executed by the first settings changing user interface application.

6. The storage medium according to claim 5, wherein the second settings changing user interface application operates as a host operating system by being executed as a process on the second operating system and the first operating system operates as a guest operating system on the virtual machine.

7. The storage medium according to claim 5, wherein the second settings changing user interface application displays a user interface on a screen of a display in a predetermined location.

8. The storage medium according to claim 5, wherein the first operating system is used as a working operating system.

9. A computer readable storage medium storing a program for providing a software user interface executable by a computer, the storage medium comprising:
an operating system; and
a settings changing user interface application executed on the operating system,
wherein the operating system communicates with another operating system and executes a change of settings requested from the other operating system.

10. A computer readable storage medium storing a program for providing a software user interface to cause a computer to execute operations, the storage medium comprising:
an operating system; and
a settings changing user interface application executed on the operating system,
wherein the settings changing user interface application inputs a request of changing of settings, requests an execution of the changing of settings to another operating system, and outputs a execution result of the changing of settings by the other operating system.

11. The storage medium according to claim 10, wherein the settings changing user interface application displays a user interface on a screen of a display in a predetermined location.

12. A method for providing a software user interface on a computer comprising:
the computer comprises:
a first settings changing user interface application running on a first operating system; and
a second settings changing user interface application running on a second operating system, the second settings changing user interface application providing an equal function to a part of a user interface function provided by the first settings changing user interface application;
the method comprising:
inputting a request of changes of settings by the second settings changing user interface application;
executing the changes of settings based on the request input by the second settings changing user interface application by the first settings changing user interface application; and
outputting a result of the changes of settings executed by the first settings changing user interface application by the second settings changing user interface application.

13. The method according to claim 12, wherein the second settings changing user interface application operates as a host operating system by being executed as a process on the second operating system and the first operating system operates as a guest operating system on the virtual machine.

14. The method according to claim 12, comprises displaying a user interface on a screen of a display in a predetermined location by the second settings changing user interface application.

15. The method according to claim 12, wherein the first operating system is usually used as a working operating system.

16. A method of providing a software user interface, comprising
transmitting a request related to a setting of a first operating system from a second operating system; and
changing said setting via an interface of the first operating system responsive to the request and providing a notification of said changing via an interface of the second operating system.
